(19) United States
(12) Patent Application Publication
(10) Pub. No.: US 2012/0031869 A1
(43) Pub. Date: Feb. 9, 2012

(54) PET PREFORM FOR A TRANSIENTLY-EXTANT DRINK BOTTLE

(76) Inventor: Alan Bauer, Jerusalem (IL)

(21) Appl. No.: 12/852,484

(22) Filed: Aug. 8, 2010

(51) Int. Cl. B65D 1/04; B32B 1/08; B29C 49/02; B29C 49/42

(52) U.S. Cl. 215/6; 264/573; 428/36.92; 264/250

(57) ABSTRACT

Performs used in the preperation of a transiently-extant drink bottle is described. The drink bottle may be formed from joining two separate closable fluid holding compartments, each compartment capable of holding a unique drinking fluid. Joining of the compartments tends to allow for greater consumer choice in beverage selection as well as potential cooling of one beverage through its non-contact proximity to a second frozen beverage. PET preforms having joining elements can also aid in joining of closable fluid holding compartments to form a transiently-extant disposable drink bottle.

This application claims priority from U.S. Provisional Patent Application 61/027,454, filed 9 Feb., 2008, the contents of which are hereby incorporated by reference.

### FIELD OF THE INVENTION

The present invention relates to a PET preform used in producing a disposable drink bottle that minimally includes two separable closable fluid holding compartments that may be filled with drinking fluids. In an embodiment, the bottle comes with a number of external caps matching the number of compartments to allow for user-controlled access to one or more of the drinking fluids. The fluid holding compartments can be joined and separated easily and repeatedly. One or more joining elements associated with a neck region of a PET preform and the resulting PET closable fluid holding compartment may aid in such joining and separation.

### SUMMARY OF INVENTION

The present invention in some embodiments allows for cooling of one drinking fluid by virtue of its non-contact proximity to a frozen drinking fluid. Additionally, the present invention allows drink fluid users to take more than one drink with them in an exchangeable component, single PET bottle format. The invention in some embodiments includes at least one joining element associated with a neck region of a PET preform that allows for facile joining/separation of PET bottles for the purpose of cooling drinks and/or taking multiple unique beverages in a single transiently-extant PET “bottle”.

The invention includes a PET preform for use in preparation of a transiently-extant PET drink bottle including: a first PET preform including a first joining element associated with the first PET preform, wherein the first joining element may allow for detachable attachment to a complementary second joining element associated with a second PET preform.

In one aspect of the invention, the first PET preform is blow-molded into a closable fluid holding compartment that retains the first joining element and the second PET preform is blow-molded into a closable fluid holding compartment that retains the second joining element.

In another aspect of the invention, the first joining element includes at least one male attachment feature.

In another aspect of the invention, the second joining element includes at least one female attachment feature.

In another aspect of the invention, the first joining element is located in a neck region of the first PET preform, and said second joining element is located in a neck region of the second PET preform.

In another aspect of the invention, the first joining element is dressed over a neck region of the first PET preform, and the second joining element is dressed over a second neck region of the second PET preform.

The invention additionally includes a method for joining PET closable holding compartments, comprising: casting a first PET preform, the first preform having at least a first joining element; forming a first closable fluid holding compartment from the first PET preform; casting a second PET preform, the second preform having at least a second joining element complementary to the first joining element; forming a second closable fluid holding compartment from the second PET preform; and joining the first and second fluid holding compartments through interaction of the first and second joining elements, wherein the first joining element is detachably attached to the second joining element.

In one aspect of the method, the first joining element is located in a first neck region of the first PET preform, and the second joining element is located in a second neck region of the second PET preform.

In another aspect of the method, the first joining element includes a male feature, and the second joining element includes a complementary female feature.

In another aspect of the method, each of the first and second closable holding compartments has an external cap.

The invention includes a transiently-extant disposable drink bottle, comprising: a first closable fluid holding compartment manufactured from a PET preform; and a second closable fluid holding compartment manufactured from a PET preform, wherein each of the first and second closable fluid holding compartments includes a plurality of joining elements, each joining element on the first compartment being complementary for detachable attachment to a complementary joining element on the second compartment.

In an aspect of the invention, each closable fluid holding compartment has an external cap.

In another aspect of the invention, each closable fluid holding compartment has a joining face, and the joining elements of the each closable fluid holding compartment appears on its associated joining face.

In another aspect of the invention, the joining elements include male and female attachment features.

In another aspect of the invention, the joining elements include features that are realized as protrusions and indentations.

In another aspect of the invention, the protrusions and indentations are in the form of the word Pepsi®.

In another aspect of the invention, the protrusions and indentations are in the form of the word Coke®.

In another aspect of the invention, the protrusions and indentations are in the form of the expression Coca-Cola®.

In another aspect of the invention, the closable fluid holding compartments are detached.

In another aspect of the invention, the closable fluid holding compartments are detachably attached together.

In an aspect of the invention, there is provided a PET preform having at least one joining element.

In one aspect of the invention, the joining element may be produced as a part of the PET preform.

In another aspect of the invention, the joining element may be a part of the neck region of the PET preform. The joining element in a preferred embodiment may have the joining element being part of the ring in the neck region of a preform.

In another aspect of the invention, a PET preform may be blow-molded into a PET closable fluid holding compartment in which at least one joining element is associated with a neck region of the closable fluid holding compartment after manufacture of the compartment.

In another aspect of the invention, a PET closable fluid holding compartment with a first joining element that may be joined to a second joining element found on a second PET closable fluid holding compartment is provided. Each closable fluid holding compartment may hold the same or different drinking fluids.

The invention may additionally include a PET closable fluid holding compartment with a first joining element, the joining element being associated with the neck region of the compartment. The first joining element may be joined with a second joining element associated with a second closable fluid holding compartment. The second joining element of the second closable fluid holding compartment may be associated with the body, cap or neck region of the second closable fluid holding compartment.

In still another aspect of the invention, a PET closable fluid holding compartment may provide at least one joining element added to the neck region after blow-molding of a PET preform into the closable fluid holding compartment.

Aspects of the invention also provide for a method for preparing a transiently-extant PET bottle including minimally two closable fluid holding compartments, including the following steps: casting a PET preform, the preform having at least one joining element; forming a closable fluid holding compartment from the PET preform; providing a second closable fluid holding compartment, the closable fluid holding compartment having at least one joining element in its neck region; and, joining the closable fluid holding compartments through interaction of joining elements.

In one aspect of the method, at least one joining element may be located in a neck region of said preform.

In another aspect of the method, the closable fluid holding compartments may have separate external caps.

In another aspect of the method, the at least one joining element may be associated with the neck region of the PET preform. Alternatively, the at least one joining element may be dressed over the neck region of a PET closable fillable compartment after blow-molding of the PET preform.

In another aspect of the method, each PET preform may be blow molded into a closable fillable compartment, each compartment being able to receive a drinking fluid and a removable cap.

Aspects of the invention may additionally include a transiently-extant drink bottle formed from two or more closable fluid holding compartments, each closable fluid holding compartment sporting at least one joining element.

One aspect of the invention may provide sides of the closable fluid holding compartments being complementary, meaning that they can be placed easily side by side prior to joining of closable fluid holding compartments through the agency of a plurality of joining elements associated with a plurality of compartments.

In another aspect of the invention, joining elements may include male and female attachment features.

In another aspect of the invention, the male and female features associated with joining elements may allow for facile joining and separation of closed internal compartments associated with a transiently-extant drink bottle.

In another aspect of the invention, each closable fluid holding compartment may have an external cap.

In another aspect of the invention, joining faces of closable fluid holding compartments may be complementary.

In another aspect of the invention, joining elements may include features that are realized as protrusions and indentations.

In another aspect of the invention, the closable fluid holding compartments may be sold separately.

In another aspect of the invention, the closable fluid holding compartments may be sold together.

In another aspect of the invention, the closable fluid holding compartments may be joined by a user.

### BRIEF DESCRIPTION OF THE FIGURES

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 shows a standard 20 gram PET perform in an exemplary embodiment.

FIG. 2 shows the steps involved in blow-molding a PET preform into a final PET bottle.

FIG. 3 shows the “neck region” of a PET preform and fully-blown PET bottle.

FIG. 4 shows a PET preform in actual and schematic view.

FIG. 5 shows a PET preform sporting a joining element in its neck region.

FIG. 6 shows some version of joining elements that may be associated with a neck region of a PET preform.

FIG. 7 shows an asymetrically blown PET bottle that allows for joining element in neck region to be available for transient joining of two or more PET bottles.

FIG. 8 shows two PET closed internal compartments with joining elements in their neck and body regions transiently joined to form a disposable PET drink bottle.

FIG. 9 shows two PET closed internal compartments with joining elements in their neck regions transiently joined to form a disposable PET drink bottle.

FIGS. 10-13 show multiple non-limiting means of joining disposable PET bottles.

FIG. 14 shows an embodiment for attaching closable fluid holding compartments through joining elements associated with caps.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances alternative materials such as glass, carton or metal may be employed in the present invention. The unique aspect of the invention, independent of material or specific drinking fluid, is a PET preform that includes a joining element, preferably in the neck region of the preform.

### DEFINITIONS

To better understand the various aspects of the invention described in the present invention, certain terms are explained in detail below.

A “PET disposable drink bottle” generally refers to a bottle made at least in part of polyethylene terephthalate and comprises at least two separate fillable closable fluid holding compartments that can each hold a unique drinking fluid and can be opened and closed separately by a user. A “PET disposable bottle” may hold any material, including solids and liquids.

“Fluid” or “drinking fluid” generally refers to any liquid beverage that may be imbibed. Water, fruit juices, milk and carbonated soft drinks are some non-limiting examples of drinking fluids. Drinking fluids in a PET disposable drink bottle or a disposable drink bottle reside in minimally two closable fillable fluid holding compartments. “Drinking fluids” for the present invention are generally non-alcoholic beverages.

“Freezer” and “refrigerator” are readily understood and have their normal meaning in the art.

“Closed internal compartment”, “compartment” and “closable fluid holding compartment” generally refer to an element of a transiently-extant drink bottle or transiently-extant PET drink bottle. The element can represent a finable closable fluid holding compartment that may be made proximate to a second compartment of the same transiently-extant drink bottle. Specifically, a “closable fluid holding compartment” can be a spatial element (of any shape or volume) capable of holding a drinking fluid alone, without fluid contact from drinking fluid in another closable fluid holding compartment. Drinking fluid in one compartment may be frozen in a freezer or freezer unit of a refrigerator prior to addition of drinking fluid to a second closed internal compartment of the same transient drink bottle. The closed internal compartments of a single disposable PET bottle may be manufactured separately and may be transiently joined together and separated by manufacturer or user. “Closed internal compartment”, “compartment” and “closable fluid holding compartment” are herewith used interchangeably.

“Preform”, “blow-molding” and “PET preform” are readily understood and generally have their normal meanings in the art as they refer to PET bottle preparation. Preforms may include joining elements in the neck region of a preform to aid in transient joining of PET closed internal compartments in order to form a single transiently-extant disposable PET bottle. “Neck region” of a preform can refer to a portion of a preform that does not expand during traditional PET blow-molding and generally includes the threaded region where a cap is placed and the preform material lower than and generally within 4 centimeters of this threaded region. “Neck region” may refer to the preform region as described or it may refer to a comparable region of a fully-formed blow-molded PET closable fluid holding compartment or bottle. Specifically, the “neck region” of a PET bottle generally refers to the region of the bottle that was not expanded during blow-molding.

“Joining element” generally refers to a feature that may be present on a PET preform or PET closable fluid holding compartment, according to the present invention. A joining element can include “features” that may allow for transient joining of adjacent closed internal compartments after blow-molding of PET preforms to make closed internal compartments. Such features may include, but are not limited to, protrusions and indentations, rings and rods, magnets, glue, Velcro®, and tape, latches, male and female features. Joining elements may even be associated with a plastic or paper label on the compartments. “Joining face” refers to a side of a closable fluid holding compartment that faces another closable fluid holding compartment when said compartments are transiently joined. Joining faces are “complementary” when they can easily be placed side by side while joining elements are used to transiently join closable fluid holding compartments. A joining element may be produced with preform when a PET preform is cast or molded, or alternatively a joining element may be dressed on or added to a PET preform or PET closable fluid holding compartment. Alternatively, a joining element may be added to a PET preform prior to its blow-molding into a PET bottle. Joining elements may be made of PET or other appropriate materials including but not limited to PET or other plastics. “Male” and “female” with regard to attachment features associated with joining elements have their normal meaning in the physical arts. A “male” feature may be inserted into a “female” feature to facilitate transient joining

“Cap” or “External cap” generally refers to a cap for a transiently-extant drink bottle according to the present invention, with the cap possibly sitting above an opening associated with a single closable fluid holding compartment. A cap or external cap is typically associated with one closed compartment of a transiently-extant drink bottle according to the present invention. Opening of cap allows for access to drinking fluid in a closable fluid holding compartment. The external cap may have a nipple to allow a user to drink directly from a PET drink bottle. Features of joining elements may alternatively be associated with one or more caps. Joining elements may be associated with a cap.

“User” is a person who may obtain closed internal compartments and drink the drinking fluid contents of a transiently-extant PET drink bottle or transiently-extant disposable drink bottle, or otherwise handle or manipulate a bottle or its compartments.

“Transiently-extant” with respect to a disposable PET drink bottle or drink bottle generally refers to a drink bottle made from joining two or more closable fluid holding compartments in a non-permanent arrangement. Closable fluid holding compartments may be manufactured separately and may be joined and separated, freely and repeatedly by either a manufacturer or user. Thus, any drink bottle, plastic or otherwise, described herein may exist transiently through joining of closable fluid holding compartments through joining elements associated with said compartments. Though a user may choose not to separate closable fluid holding compartments, the resultant transiently-extant drink bottle may be considered “transiently-extant” due to its inherent ability to be separated into compartments at any time. There can be no time limit to the transient nature of physical joining of the closed internal compartment.

“PET” and “PETE” are well understood and generally have their normal meaning in the arts and may refer to polyethylene terephthalate. The term “PET” with respect to preforms and bottles may also include other organic materials such as co-polymers, color pigments, inorganic chemicals or the like. PET preforms can refer to any preform that includes PET or PET-like material. It is understood that the devices and methods associated with the present invention may be applied to bottles made of materials other than PET or the like, whether such bottles are disposable or not.

“Lip” generally refers to a physical protrosion from the top or the bottom of a closed internal compartment that allows for transient joining of two or more closed internal compartments. The lip of one closed internal compartment may sit over and holds in place a second closed internal compartment.

### GENERAL DESCRIPTION

During summer months or at times of prolonged exercise, cooled drinking fluids tend to be preferred. General methods of cooling fluids for drinking involve three approaches: placing the fluid of interest into a refrigerator; or, placing the fluid of interest in a drink bottle in a freezer unit of a refrigerator; or, adding ice or ice equivalents to the drinking fluid. All three methods have inherent weaknesses. Fluids cooled in a standard refrigerator generally return to room temperature within one hour (depending on specific atmospheric conditions). Fluids placed in a freezer are generally not available for consumption until a significant amount of the fluid has thawed. At that time, the fluid composition (and taste) may have changed due to the uneven thawing of fluid components. And finally, adding ice to a fluid is not always possible for small-neck bottles, and the added ice inherently dilutes the original drinking fluid and makes it less appealing. There are water bottles that sport an undrinkable “freezer stick” that may be frozen prior to its addition to the contents of the water bottle. The problem with said freezer sticks is that they do not cool fluids well (due to their necessarily small size) and they take up precious volume with material that is not consumed by a user. The material in the freezer stick (water and gel) reduces the volume of available fluids in a fixed bottle volume. This weakness and that of its poor cooling characteristics for room temperature drinks make for a unsatisfactory fluid cooling system.

Aspects of the invention described herewith have particular application to the disposable plastic bottle market. The methods and devices described herewith and in U.S. Provisional Patent Application No. 61/027,454 of common inventor, are intended primarily but not exclusively for application with PET bottle manufacturing procedures. For any bottle to enter the mass-produced PET bottle market, there must be no significant change in practice for production of bottles. Beverage manufacture practice today includes production of disposable bottles on site from small precursors (preforms) made of PET and PET-copolymer combinations. Bottles can be produced at a rate of 15,000 to 30,000 bottles per hour per molding machine. Preforms are generally casted on site and then blow-molded into bottles. When a preform is placed in a mold and then treated with hot air, PET below the neck region expands to assume the dimensions and shape of the mold. The neck region, including threads for a cap and 2-5 centimeters beneath it, remains unchanged from the preform, as it remains outside of the bottle mold. After bottle production, the bottles are filled with drinking fluids on site and then prepared for shipping to distributors. In embodiments of the present invention, a transiently-extant PET drink bottle is composed minimally of two closed internal compartments. Each closed internal compartment may be made from a single PET preform by a procedure substantially identical to the one in use by beverage manufacturers today. In an embodiment, each mold yields only half of a transiently-extant bottle, or a single closable and fillable fluid holding compartment. Such a compartment has a bottle neck which is amenable to both filling and capping. Additionally, the preform used in closed internal compartment formation may have a joining feature, generally located in the neck region in the embodiment. The joining feature may be a part of the preform or it may be added after the preform is blown into a closable fluid holding compartment. The features of a joining element are determined to allow facile joining and separation of multiple closed internal compartments to form a single transiently-extant disposable PET bottle. Joining of closable fluid holding compartments may be effected by joining elements partially associated with a neck region of PET preforms used in closed internal compartment production.

The specific details of structural features that allow for joining and separating of distinct drink compartments are described in the exemplary embodiments described below. One aspect of the transient attachment scheme has some of the attachment or joining elements associated with the non-expanding neck region of PET preforms. Thus, PET preforms are produced with at least one joining element associated with each preform, said joining element preferably located in the non-expanding neck region. Alternatively, joining elements may be dressed on the neck or other region of PET closed internal compartment after blow-molding of a PET preform into a closable fluid holding compartment. The implications include:

1) Manufacture of disposable PET drink bottles may continue to follow the standard PET blow-molding technology, and having the additional presence of joining elements in or around the neck region of a preform used to form the product drink compartments. PET blanks (“preforms”) may be prepared with joining elements allowing for transient joining of separate fully-blown PET closable fluid holding compartments. Such elements may be a part of the PET preform or may be added to a PET closed internal compartment after expansion of PET preform.

2) Having symmetrically-disposed indentations and protrusions or other appropriate features on joining elements of a preform allows for reversible joining of two fully-blown closable fluid holding compartments. For example, blow-molding of PET preform into a final compartment may be asymmetric, so that one side of a first closable fluid holding compartment is complementary to a side of a second closable fluid holding compartment.

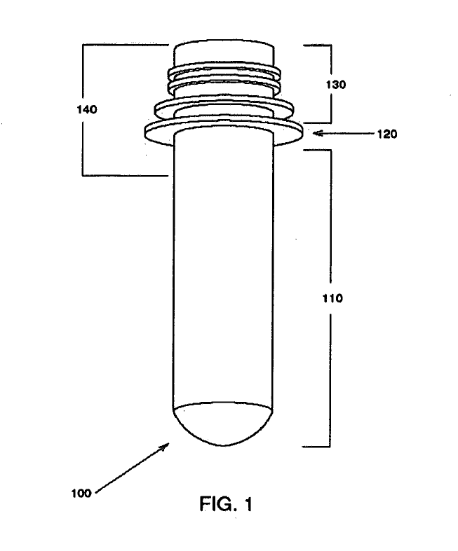

Aspects of the present invention thus tend to have direct applicability for disposable PET soft drink bottles that are sold, for example, in the tens of millions of units in the United States each day. Additionally, implementation of aspects of the present invention can involve no change in blow-molding techniques, for example with any alteration being reserved possibly for the molds and preforms from which the PET preforms and bottles are produced. Alternatively, joining elements may be made of non-PET material and are dressed on a PET closable fluid holding compartment after production of said compartment. Bottle molds are typically routinely changed as a function of marketing and style, while preforms may be produced in any shape, although the standard version (see for example FIG. 1) is most popular. Finally, aspects of the present invention also allow for cooling of one drinking fluid by its non-contact proximity to another, frozen, drinking fluid.

### EXEMPLARY EMBODIMENTS

Reference is made to FIG. 1 which shows a picture of a standard commercially-available 20-gram PET preform (100). The preform (100) has several elements. The first is the body (110) of the preform (100). The body (110) can expand when the preform (100) is subjected to heat in a bottle mold. Above the body (110) is a ring (120) that is generally held by a machine (not shown) during liquid filling of blow-molded bottles. Above the ring (120) is the cap region (130) with grooves in place for acceptance of the bottle cap (not shown). Neck region (140) is the portion of the preform (100) that does not expand during blow-molding or other expansion processes.

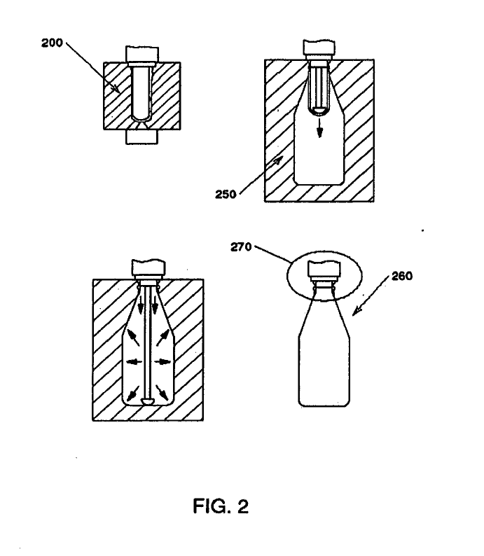

One is referred to FIG. 2 for further elucidation of the production process for disposable PET bottles. As shown, preform (200) undergoes a multi-step process by which the preform (200) is expanded with hot air in a mold (250) to assume the shape of a final bottle (260). The unexpanded region (270) of the bottle remains as it was in the original preform (200). As discussed below, it is in this unexpanded region (270) where some joining elements may be placed.

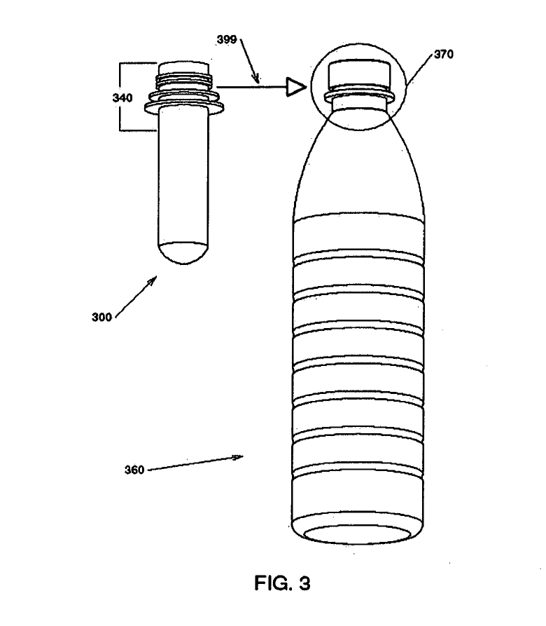

FIG. 3 further clarifies the relationship between a preform (300) and a final PET drink bottle (360). The neck region (340) of the preform (300) is realized as the unexpanded region (370) of the final PET drink bottle (360). Arrow (399) reinforces this identity of elements from preform (300) to final PET drink bottle (360).

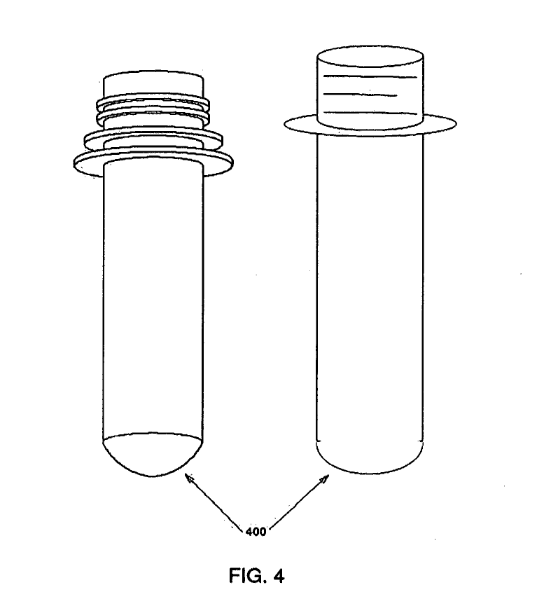

In FIG. 4, preform (400) is shown as in the previous three figures as well as in the form of a schematic drawing. The drawing (right side of figure) will be used for all further discussion below.

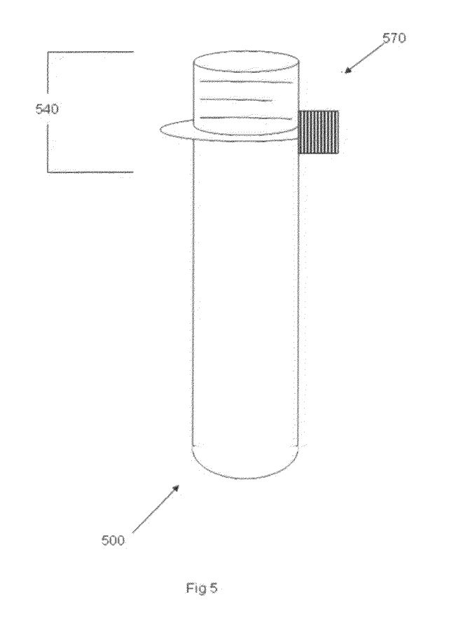

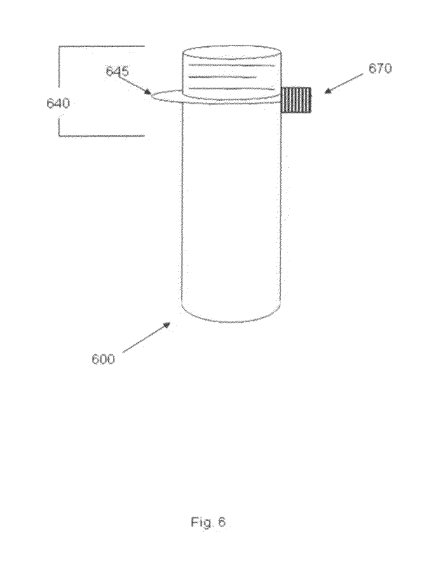

FIG. 5 shows a preform (500) with a joining element (570) in the neck region (540) of the preform. A preform (500) may be made of PET, combinations of PET and other organic materials or from materials other than PET. FIG. 6. shows a PET preform (600) in which a joining element (670) is associated with the ring (645) of the PET neck region (640). The joining element (670) may be attached transiently to another joining element associated with another PET preform (not shown). The joining element may include “male” and “female” features and may be partially detatachable from the neck region so as to effect transient joining

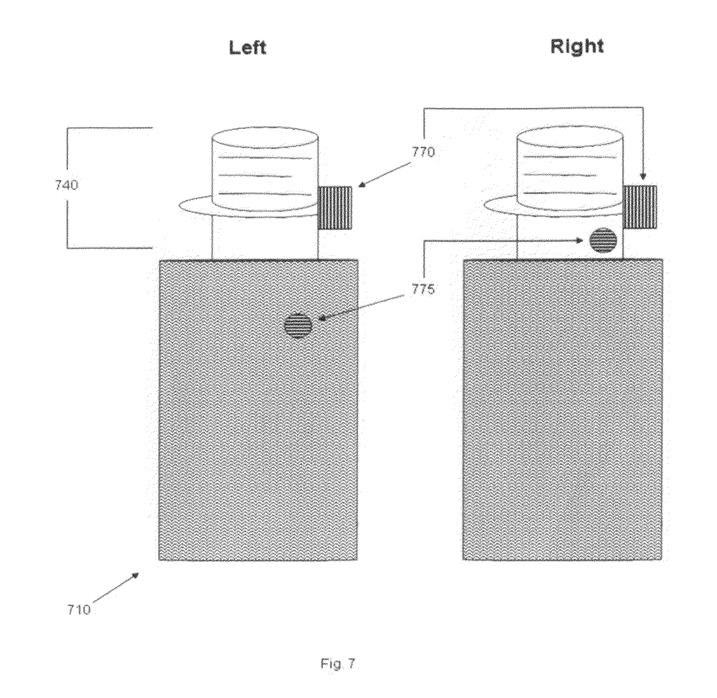

FIG. 7 (Left) shows a closable fluid holding compartment (710) produced from a PET preform (not shown). The closable fluid holding compartment (710) has at least two joining elements (770, 775). One joining element (770) is associated with the neck region (740) of the closable fluid holding compartment (710), while the other (775) is associated with the body of the closable fluid holding compartment (710). The joining elements (770) may be part of the original PET preform (not shown) used in forming the closable fluid holding compartment (710), or they may be added during blow-molding of preform (now shown) or they may be added after closable fluid holding compartment (710) formation. In the latter case, one or more joining elements may be added either before or after bottle filling with drinking liquid. On the Right side of FIG. 7, both joining elements (770, 775) are located in and/or near the neck region.

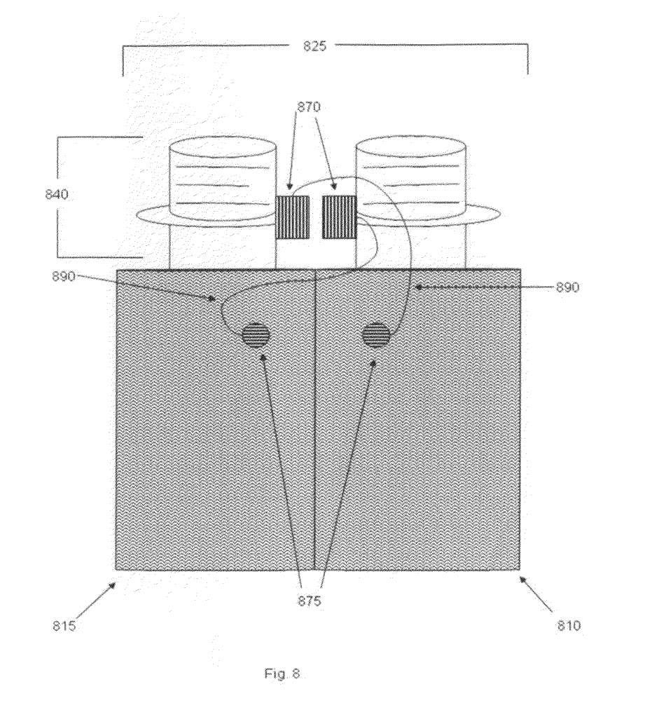

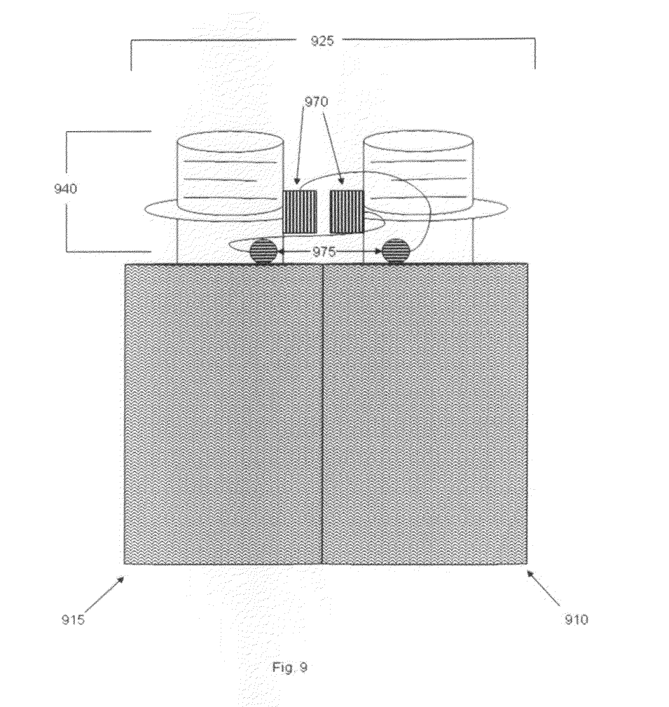

Attention is turned to FIG. 8, in which two closable fluid holding compartments (810, 815) are joined to form a single transiently-extant PET drink bottle (825). Joining elements (870, 875) are attached, where one joining element from a first closable fluid holding compartment (810) is attached to a joining element associated with a second closable fluid holding compartment (815) and vice versa. Attaching threads (890) may be made of PET and be an integral part of the PET closed internal compartment. Alternatively, attaching threads, as well as joining element (870) may be dressed, attached and/or connected on a closable fluid holding compartment (810, 815) after the latter's formation. Note that both joining elements (FIG. 9, 970, 975) may be associated with the neck region (940) of closable fluid holding compartments (910, 915) to form a transiently-extant PET drink bottle (925).

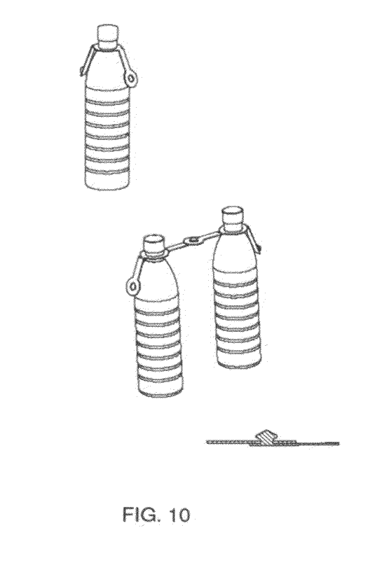

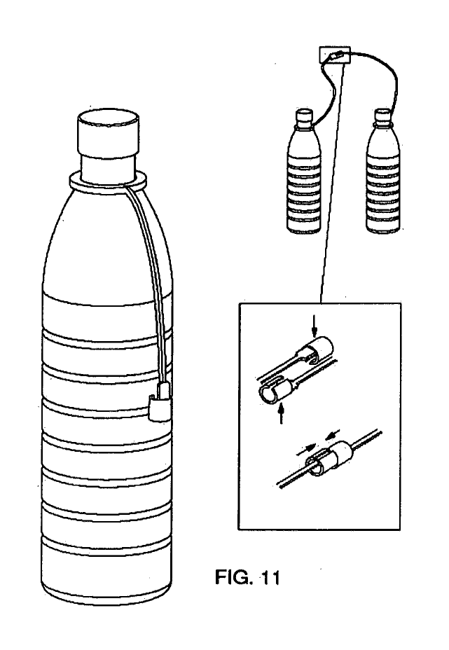

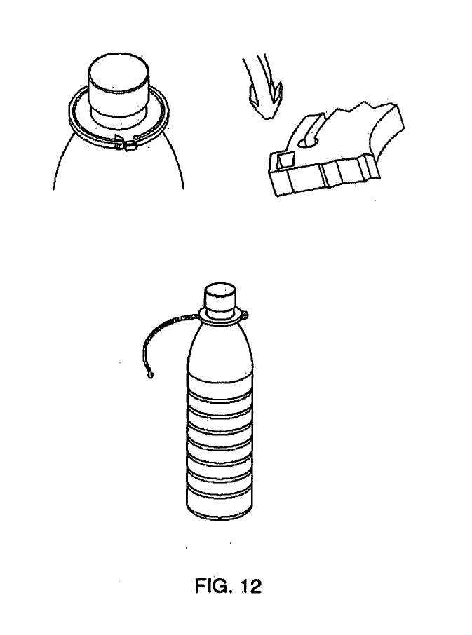

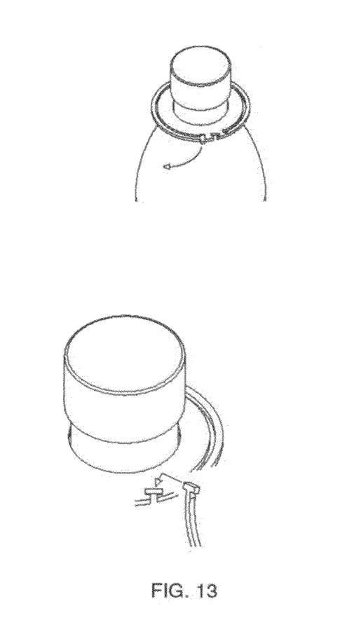

FIGS. 10-13 show various arrangements of joining elements associated with neck regions of PET bottles. In the embodiments, the joining elements are either part of a PET preform or are added to a closable fluid holding compartment after blow-molding of PET preforms. The joining elements as shown allow for transient joining of closable fillable drink compartments. In preferred embodiments, joining elements include both a male and a female feature. The male and female features may be part of a single joining element or may be realized as two distinct joining elements. The joining elements are generally associated with the neck region of a PET bottle though they may be located anywhere on a PET preform or PET closable fluid holding compartment.

One of the advantages of the embodiments herein described is the ability for a user to purchase a closable fluid holding compartment with a room-temperature drinking fluid as well as a closable fluid holding compartment with a frozen drinking fluid. At time of purchase, he/she can join the two closable fluid holding compartments to form a transiently-extant PET drink bottle that allows for cooling of the room-temperature drinking fluid by virtue of its non-contact proximity to the frozen drinking fluid. In various embodiments, various detachable attachment mechanisms may be used, including snap-fit or other friction fit attachments, male-female connectors, Velcro®, and/or other detachable attachment structures.

One of the reasons why billions of PET bottles are being thrown away annually in the US is their current lack of extended functionality. One just drinks the contents of a beverage bottle and throws the bottle away. Landfills are filling up with these bottles and many municipalities are looking for means of reducing the future presence of PET drink bottles. The present invention, due to its ability to provide extended periods of drink cooling as well as user-selected, alterable drink pairings may tend to reduce the future number of PET bottles annually thrown away.

Another advantage of the present invention relates to beverage freshness. If both closed internal compartments joined to form a single transiently-extant drink bottle contain the same beverage, opening one of the closed internal compartments and drinking its drinking fluid content leaves the other closed internal compartment closed and its contents fresh. This application is most relevant for carbonated beverages that have a tendency for losing their gas (“going flat”) as well as for milk which often goes bad shortly after opening of a milk bottle.

One of the advantages of the present invention is the ability to allow for cross-marketing of products. As only products that have joining elements may be joined, a company may use the present invention to single out its products for active joining by users. Such an arrangement generates brand loyalty as well as brand recognition. By seeing the joining elements on a given closable fluid holding compartment, a consumer will know that the product belongs to the company making PET bottles according to devices and methods of the present invention.

Attention is turned to FIG. 14 which shows an alternative means of joining multiple closable fluid holding compartments (1410). In this embodiment, joining elements (1470 male; 1475 female) are located, at least in part, on the caps (1460) of closable fluid holding compartments (1410). By placing all of the joining elements (1470, 1475) in the caps (1460), one avoids any need to change pre-existing PET preform shape(s). When closable fluid holding compartments (1410) are closed, caps (1460) may be joined through joining elements (1470, 1475) associated with caps (1460). When one wishes to drink, one may detach joining elements (1470, 1475) in order to allow opening of a cap (1460) (not shown).

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. The transiently-extant drink bottles and closable fluid holding compartments described in the present invention may be of any size and shape. Since any drinking fluids may be added to a closable fluid holding compartment, users will have the ability to choose their favorite drinks to take along with them. By reusing the bottle, significantly fewer disposable bottles will need to be produced on an annual basis. Beverage bottles made from paper carton such as those routinely employed for milk and milk products are also appropriate for the present invention. The specific means of joining carton-based closed internal compartments may be the subject of another patent application filing. Transiently-extant PET bottles prepared as per the instant invention may hold material other than beverages including but not limited to soap, shampoo, dry goods, and water.

1. A PET preform for use in preparation of a transiently-extant PET drink bottle including:
a first PET preform including a first joining element associated with said first PET preform,
wherein said first joining element may allow for detachable attachment to a complementary second joining element associated with a second PET preform.

2. The PET preform according to claim 1, wherein said first PET preform is blow-molded into a closable fluid holding compartment that retains said first joining element and said second PET preform is blow-molded into a closable fluid holding compartment that retains said second joining element.

3. The PET preform according to claim 2, wherein said first joining element includes at least one male attachment feature.

4. The PET preform according to claim 2, wherein said second joining element includes at least one female attachment feature.

5. The PET preform according to claim 1, wherein said first joining element is located in a neck region of said first PET preform, and said second joining element is located in a neck region of said second PET preform.

6. The PET preform according to claim 1, wherein said first joining element is dressed over a neck region of the first PET preform, and said second joining element is dressed over a second neck region of the second PET preform.

7. A method for joining PET closable holding compartments, comprising:
casting a first PET preform, said first preform having at least a first joining element;
forming a first closable fluid holding compartment from said first PET preform;
casting a second PET preform, said second preform having at least a second joining element complementary to the first joining element;
forming a second closable fluid holding compartment from said second PET preform; and
joining said first and second fluid holding compartments through interaction of the first and second joining elements, wherein said first joining element is detachably attached to said second joining element.

8. The method according to claim 7, wherein said first joining element is located in a first neck region of the first PET preform, and the second joining element is located in a second neck region of the second PET preform.

9. The method according to claim 8, wherein said first joining element includes a male feature, and said second joining element includes a complementary female feature.

10. The method according to claim 9, wherein each of the first and second closable holding compartments has an external cap.

11. A transiently-extant disposable drink bottle, comprising:
a first closable fluid holding compartment manufactured from a PET preform; and
a second closable fluid holding compartment manufactured from a PET preform, wherein each of the first and second closable fluid holding compartments includes a plurality of joining elements, each joining element on said first closable fluid holding compartment preform being complementary for detachable attachment to a complementary joining element on said second closable fluid holding compartment.

12. The transiently-extant drink bottle according to claim 11, wherein each closable fluid holding compartment has an external cap.

13. The transiently-extant drink bottle according to claim 12, wherein each closable fluid holding compartment has a joining face, and the joining elements of the each closable fluid holding compartment appears on its associated joining face.

14. The transiently-extant drink bottle according to claim 13, wherein said joining elements include male and female attachment features.

15. The transiently-extant drink bottle according to claim 14, wherein said joining elements include features that are realized as protrusions and indentations.

16. The transiently-extant drink bottle according to claim 15, wherein said protrusions and indentations are in the form of the word Pepsi®.

17. The transiently-extant drink bottle according to claim 14, wherein said protrusions and indentations are in the form of the word Coke®.

18. The transiently-extant drink bottle according to claim 14, wherein said protrusions and indentations are in the form of the expression Coca-Cola®.

19. The transiently-extant drink bottle according to claim 13, wherein said closable fluid holding compartments are detached.

20. The transiently-extant drink bottle according to claim 13, wherein said closable fluid holding compartments are detachably attached together.
